(19) United States
(12) Patent Application Publication
(10) Pub. No.: US 2026/0118816 A1
(43) Pub. Date: Apr. 30, 2026

(54) IMAGE FORMING APPARATUS

(71) Applicant: CANON KABUSHIKI KAISHA, Tokyo (JP)

(72) Inventors: TETSUHIRO YOSHIMOTO, Tokyo (JP); YOSUKE HATA, Chiba (JP); YOSHITAKA YAMAZAKI, Chiba (JP); KAZUNORI MIYAKE, Chiba (JP)

(21) Appl. No.: 19/357,187

(22) Filed: Oct. 14, 2025

(30) Foreign Application Priority Data
Oct. 24, 2024 (JP) 2024-187395

(51) Int. Cl. G03G 15/00; G03G 21/16

(52) U.S. Cl. CPC G03G 15/80; G03G 21/1619; G03G 21/1652; G03G 2221/166; G03G 2221/1678

(57) ABSTRACT

An image forming apparatus configured to form an image on a recording material includes an apparatus body including at least a first frame body and a second frame body which are disposed in a vertical direction, a first electrical member disposed in the first frame body and configured to operate physically based on electrical control, a second electrical member disposed in the second frame body and configured to operate physically based on electrical control, a first control board disposed in the first frame body, connected to the first electrical member, and configured to control the first electrical member, and a second control board disposed in the second frame body, connected to the second electrical member, and configured to control the second electrical member.

### BACKGROUND

### Field of the Technology

This disclosure relates to an image forming apparatus such as a printer, a copier, a facsimile, or an integrated machine.

### Description of the Related Art

According to Japanese Patent Laid-Open No. 2015-18173, an image forming apparatus including a plurality of electrical members and a plurality of control boards to control those members is disclosed. In image forming apparatuses, substantial wire routing is implemented to connect a plurality of electrical members and a plurality of control boards. However, in cases where such configurations include the plurality of electrical members and the plurality of control boards, there is a concern that maintainability may pose an issue.

### SUMMARY

According to a first aspect of the present disclosure, an image forming apparatus configured to form an image on a recording material includes an apparatus body including at least a first frame body and a second frame body which are disposed in a vertical direction, a first electrical member disposed in the first frame body and configured to operate physically based on electrical control, a second electrical member disposed in the second frame body and configured to operate physically based on electrical control, a first control board disposed in the first frame body, connected to the first electrical member, and configured to control the first electrical member, and a second control board disposed in the second frame body, connected to the second electrical member, and configured to control the second electrical member.

According to a second aspect of the present disclosure, an image forming apparatus configured to form an image on a recording material includes a first electrical member configured to operate physically based on electrical control, a second electrical member configured to operate physically based on electrical control, a first control board that is disposed to overlap the first electrical member when the image forming apparatus is viewed from a rear side, is connected to the first electrical member, and is configured to control drive of the first electrical member, and a second control board that is disposed to overlap the second electrical member when the image forming apparatus is viewed from the rear side, is connected to the second electrical member, and is configured to control drive of the second electrical member,

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration of an image forming apparatus of this embodiment.

FIG. 2 is a schematic diagram illustrating a separation configuration of the image forming apparatus.

FIG. 3A is a schematic diagram illustrating a sheet discharge frame body.

FIG. 3B is a schematic diagram illustrating an imaging frame body.

FIG. 3C is a schematic diagram illustrating a sheet supply frame body.

FIG. 4 is a block diagram illustrating an example of an electrical system.

FIG. 5A is a diagram for explaining driving signals between an application specific integrated circuit (ASIC) and a stepping motor.

FIG. 5B is a diagram for explaining driving signals between the ASIC and a direct current (DC) brushless fan.

FIG. 5C is a diagram for explaining driving signals between the ASIC and a direct current (DC) brush motor.

FIG. 5D is a diagram for explaining driving signals between the ASIC and a DC brushless motor.

FIG. 5E is a diagram for explaining driving signals between the ASIC and an inductor sensor.

FIG. 5F is a diagram for explaining driving signals between the ASIC and an electrically erasable programmable read-only memory (EEPROM).

FIG. 5G is a diagram for explaining a driving signal between the ASIC and a photo-interrupter.

FIG. 5H is a diagram for explaining a driving signal between the ASIC and a main switch.

FIG. 6A is a diagram illustrating control signals between a central processing unit (CPU) and the ASIC in a bus system.

FIG. 6B is a diagram illustrating control signals between the CPU and the ASIC in a command-based system.

FIG. 7 is a diagram illustrating a layout and the wiring of the control boards and the electrical members in the electrical system of FIG. 4.

FIG. 8 is a block diagram illustrating another example of an electrical system.

FIG. 9 is a diagram illustrating a layout and the wiring of the control boards and the electrical members in the electrical system of FIG. 8.

### DESCRIPTION OF THE EMBODIMENTS

### Image Forming Apparatus

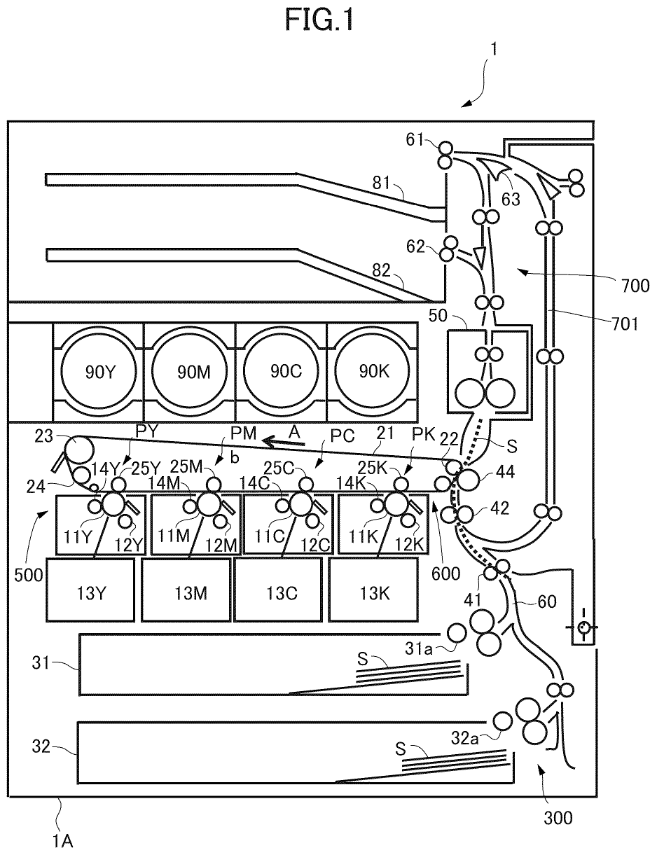

Hereinafter, this embodiment will be described. First, using FIG. 1, a schematic configuration of an image forming apparatus of this embodiment will be described. To be noted, in the following description, “front” and “rear (back side)” respectively refer to a front side and a far side of the image forming apparatus, while “right” and “left” correspond to the directions when the apparatus is viewed from the front side. The front side of the apparatus refers to a side from which a user operates the image forming apparatus to perform maintenance work, and, for example, is a side on which an operation panel is arranged, or a side from which a cassette storing a recording material is extracted. A “vertical direction” refers to a direction parallel to the gravitational direction in a state in which the image forming apparatus is installed on an installation surface such as a floor. In FIG. 1, the image forming apparatus 1 is illustrated as viewed from the front side.

The image forming apparatus 1 illustrated in FIG. 1 is a full color printer of an intermediate transfer system in which image forming units PY, PM, PC, and PK for forming toner images of four colors: yellow (Y), magenta (M), cyan (C), and black (K) are arranged to oppose an intermediate transfer belt 21. The image forming apparatus 1 includes an image formation unit 500, and the image formation unit 500 forms the toner image on the recording material S based on an image signal received from a document reading apparatus, which reads an image on a document, or external devices (not shown) such as a personal computer. The image formation unit 500 includes the image forming units PY, PM, PC, and PK and an intermediate transfer belt unit 600.

A conveyance process of the recording material S in the image forming apparatus 1 will be described. The recording material S is stored in a stacked manner in one or a plurality (in this case, two) of cassettes 31 and 32, and is commenced to be conveyed by a sheet supply unit 300. The sheet supply unit 300 includes supply rollers 31a and 32a, and the recording material S is supplied one sheet at a time from either of the cassettes 31 and 32 to a conveyance path 60 by the supply rollers 31a and 32a in synchronization with the timing of image formation. In the image forming apparatus 1 of this embodiment, the conveyance path 60 is capable of conveying the recording material S in an upward direction from below (so-called vertical conveyance system). To be noted, the recording material S encompasses various types of sheet materials, including a paper sheet such as standard paper, thick paper, rough paper, embossed paper, and coated paper, a plastic film, cloth, and the like.

The recording material S supplied from the cassettes 31 and 32 to the conveyance path 60 is conveyed to a pre-registration roller pair 41 arranged midway in the conveyance path 60. The pre-registration roller pair 41 corrects the skew of the recording material S. In particular, a leading edge of the recording material S, which is conveyed by the pre-registration roller pair 41, abuts against a nip portion of a stopped registration roller pair 42, and, thereby, the recording material S forms a loop to correct the skew. The intermediate transfer belt 21 is arranged above the registration roller pair 42, serving as a rotary member pair, and the registration roller pair 42 conveys the recording material S to a secondary transfer portion in the upward direction from below in synchronization with timing at which the toner image on the intermediate transfer belt 21 is transferred onto the recording material S. The registration roller pair 42 is arranged at a position nearest to the secondary transfer portion on an upstream side of the secondary transfer portion with respect to a conveyance direction (vertical direction) of the recording material S conveyed through the conveyance path 60. The secondary transfer portion is a nip portion formed by a secondary transfer inner roller 22 and a secondary transfer outer roller 44, which face each other across the intermediate transfer belt 21, serving as a transfer member (first transfer member, intermediate transfer member), and transfers the toner image from the intermediate transfer belt 21 onto the recording material S by applying a predetermined pressure force and secondary transfer voltage.

A formation process of the image, which is conveyed to the secondary transfer portion at a similar timing with respect to the conveyance process of the recording material S described above, will be described. First, the image forming units PY to PK will be described. However, since the image forming units PY to PK of each color are essentially the same except for the color of toner, hereinafter, the image forming unit PY for yellow will be described as a representative example. As for the image forming units PM, PC, and PK, configurations identical to those in the image forming unit PY are indicated with suffixes M, C, and K added to reference numerals in FIG. 1, and their descriptions will be omitted.

The image forming unit PY includes a photosensitive drum 11Y, a charge unit 12Y, an exposing unit 13Y, and a developing unit 14Y. A surface of the photosensitive drum 11Y, which is rotatably driven, is uniformly charged by the charge unit 12Y beforehand, and, thereafter, an electrostatic latent image is formed by laser light emitted from the exposing unit 13Y which is driven based on the image signal. Then, the electrostatic latent image formed on the photosensitive drum 11Y is developed to the toner image by the developing unit 14Y. The developing unit 14Y develops the electrostatic latent image into the toner image by rotating a developing sleeve that bears developer containing the toner and a carrier. To be noted, since the toner is consumed during the development, the toner is replenished from a toner bottle 90Y containing replenishment toner to the developing unit 14Y by rotatably driving the toner bottle 90Y at appropriate timing.

The toner image formed on the photosensitive drum 11Y receives a primary transfer voltage from a primary transfer roller 25Y, which is arranged opposite the photosensitive drum 11Y across the intermediate transfer belt 21, and, thereby, is primarily transferred from the photosensitive drum 11Y onto the intermediate transfer belt 21. Primary transfer residual toner remaining on the photosensitive drum 11Y after the primary transfer is collected by a photosensitive drum cleaner.

The intermediate transfer belt 21 is an endless belt that is moved in an arrow A direction in FIG. 1 by being tensioned by the secondary transfer inner roller 22, a drive roller 23, a tension roller 24, and the like. The image forming processes for each color described above, which are processed in parallel by the image forming units PY to PK of each color, are performed with timing that sequentially overlays each color onto toner images that have been primarily transferred upstream onto the intermediate transfer belt 21 in the movement direction. As a result, finally, the full color toner image is formed on the intermediate transfer belt 21, and the toner image is conveyed to the secondary transfer portion by the movement of the intermediate transfer belt 21. To be noted, the primary transfer rollers 25Y to 25K, the intermediate transfer belt 21, the secondary transfer inner roller 22, the drive roller 23, and the tension roller 24 described above are integrally configured as the intermediate transfer belt unit 600.

With the conveyance process and the image formation process each described above, the timing of the recording material S and the full color toner image is synchronized at the secondary transfer portion, and secondary transfer by which the toner image is transferred from the intermediate transfer belt 21 onto the recording material S is performed. Secondary transfer residual toner remaining on the intermediate transfer belt 21 after passing through the secondary transfer portion is collected from the intermediate transfer belt 21 by a belt cleaner. The recording material S onto which the toner image has been transferred is conveyed to a fixing unit 50 via the conveyance path 60, and, by being applied with heat and pressure in the fixing unit 50, the toner image is fixed on the recording material S. The fixing unit 50 includes a fixing roller that is heated by a heater (not shown) and a pressing roller that forms a fixing nip portion by coming into contact with the rotating fixing roller, and fixes the toner image on the recording material S by applying the heat and pressure with respect to the recording material S that passes through the fixing nip portion.

The recording material S on which the toner image has been fixed by the fixing unit 50 is further conveyed upward via the conveyance path 60, and is discharged outside by a sheet discharge unit 700. The sheet discharge unit 700 includes sheet discharge rollers 61 and 62 and a guide member 63, and the recording material S is discharged onto sheet discharge trays 81 and 82 by the sheet discharge rollers 61 and 62. In this embodiment, in a case where an operation mode is a duplex mode in which the image is formed on both sides of the recording material S, in order to form the image also on the opposite side of the recording material S on which the image has been formed on one side, the recording material S is conveyed to a duplex conveyance path 701. In the duplex mode, the recording material S is conveyed by the forward rotation of the sheet discharge roller 61 until a trailing edge passes through the guide member 63; thereafter, by reversing the rotation of the sheet discharge roller 61, the leading and trailing edges are interchanged, and the recording material S is conveyed to the duplex conveyance path 701. The recording material S which has been conveyed to the duplex conveyance path 701 is again returned to the registration roller pair 42. Since subsequent conveyance and image formation processes on the back side are the same as those described above, the description will be omitted. The recording material S on which the image has also been formed on the opposite side is discharged outside by the sheet discharge unit 700.

### Apparatus Body

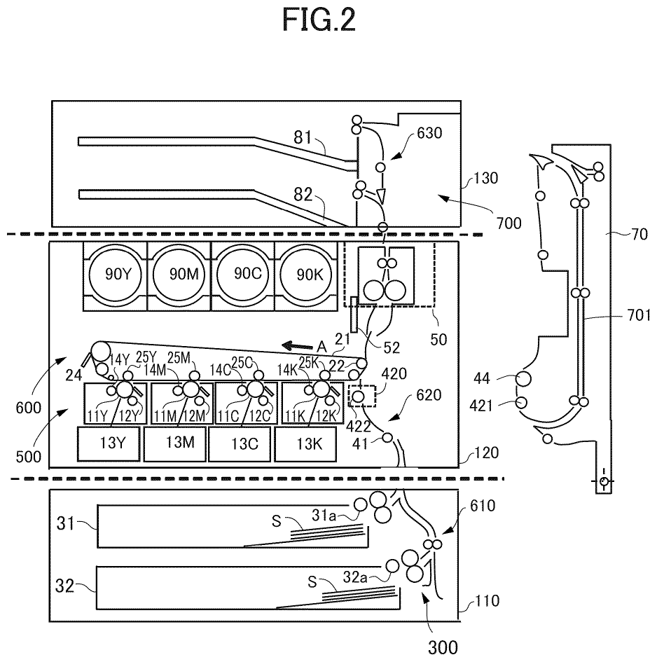

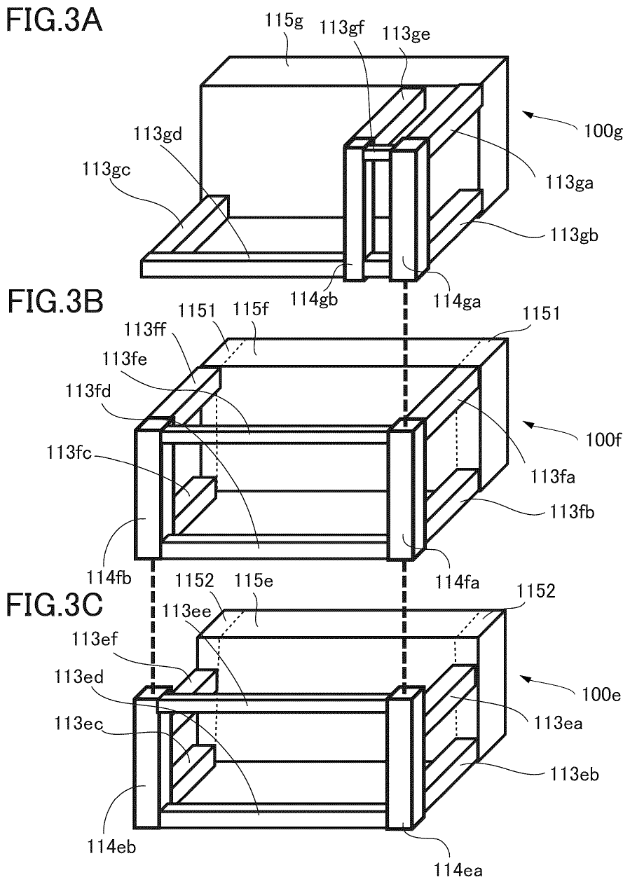

Next, with reference to FIG. 1, using FIGS. 2 to 3C, an apparatus body 1A of the image forming apparatus 1 will be described. The apparatus body 1A is a unit with an exterior cover removed from the image forming apparatus 1, and, as illustrated in FIG. 2, is divided into three separable structures: a sheet supply block 110, an imaging block 120, and a sheet discharge block 130. A “structure (block)” as defined in this embodiment refers to an assembled state in which various units including electrical members, individual electrical members, control boards, and the like described below are disposed in a frame body, described below, that is formed by combining numerous struts, stays (beams), sheet metals, and the like. To be noted, electrical members are disposed in quantities of equal to or more than one in each of the plurality of frame bodies.

In this embodiment, the apparatus body 1A, which implements a series of functions for forming the toner image on the recording material S, is configured such that the imaging block 120 is stacked on top of the sheet supply block 110, and the sheet discharge block 130 is stacked on top of the aforementioned imaging block 120. While the illustration is omitted, the sheet supply and imaging blocks 110 and 120, and the imaging and sheet discharge blocks 120 and 130 are connected, for example, by fastening a metallic plate-shaped member bridging between a strut (frame body) and another strut (frame body), which are vertically aligned, with screws in each stacked arrangement.

In addition, in this embodiment, a duplex conveyance block 70, in which the duplex conveyance path 701 is formed, is provided in advance as a separate structure from the sheet supply, imaging, and sheet discharge blocks 110, 120, and 130. The duplex conveyance block 70 is pivotably mounted with respect to the sheet supply or imaging block 110 or 120 so as to extend across the imaging and sheet discharge blocks 120 and 130. The duplex conveyance block 70 forms the conveyance path 60 (refer to FIG. 1) with the imaging and sheet discharge blocks 120 and 130. The conveyance path 60 is formed in a state in which the duplex conveyance block 70 is in a closed state, and is opened in a state in which the duplex conveyance block 70 is in an open state. Thereby, in a case where the recording material S is jammed in the conveyance path 60, by opening the duplex conveyance block 70, the user can remove a jammed recording material S from the conveyance path 60. To open the conveyance path 60, a roller 421, which constitutes one side of the rollers of the registration roller pair 42, the secondary transfer outer roller 44, and rollers, which constitute one side of the rollers of roller pairs conveying the recording material S in the conveyance path 60, are disposed in the duplex conveyance block 70. To be noted, the duplex conveyance block 70 is locked by a locking mechanism (not shown) disposed in the sheet discharge block 130 to prevent the conveyance path 60 from opening automatically in the closed state.

### Sheet Supply, Imaging, and Sheet Discharge Blocks

The sheet supply block 110 is a structure in which the sheet supply unit 300 and a sheet supply conveyance portion 610 are assembled into the sheet supply frame body 100e described below. In addition, supporting portions (not shown) such as rail members that slidably support the sheet feed cassettes 31 and 32 in a front/back direction are assembled into the sheet supply block 110. The imaging block 120 is a structure in which the image formation unit 500, an imaging conveyance portion 620, the toner bottles 90Y, 90M, 90C, and 90K, and the fixing unit 50 are assembled into an imaging frame body 100f described below. The image formation unit 500, the toner bottles 90Y, 90M, 90C, and 90K, and the fixing unit 50 may be detachably disposed in the imaging frame body 100f. The sheet discharge block 130 is a structure in which the sheet discharge unit 700 and a sheet discharge conveyance portion 630 are assembled into a sheet discharge frame body 100g described below.

In this embodiment, the conveyance path 60 that conveys the recording material S in the upward direction from below is formed by being divided into each of the sheet supply, imaging, and sheet discharge blocks 110, 120, and 130. That is, the sheet supply conveyance portion 610 forms part of the conveyance path 60 in the sheet supply block 110, the imaging conveyance portion 620 forms part of the conveyance path 60 in the imaging block 120, and the sheet discharge conveyance portion 630 forms part of the conveyance path 60 in the sheet discharge block 130.

### Sheet Discharge, Imaging, and Sheet Supply Frame Bodies

Next, using FIGS. 3A to 3C, the sheet discharge, imaging, and sheet supply frame bodies 100g, 100f, and 100e described above will be described. As illustrated in FIG. 3A, the sheet discharge frame body 100g includes a right front strut 114ga, a rear side plate 115g, a right upper stay 113ga, a right lower stay 113gb, a left stay 113gc, and a front stay 113gd. The right front strut 114ga extends in the vertical direction. The right upper and lower stays 113ga and 113gb are arranged substantially parallel to each other in vertical alignment with respect to the right front strut 114ga, and each connect the right front strut 114ga and the rear side plate 115g. Onto the rear side plate 115g, the left stay 113gc is arranged in a direction substantially perpendicular to the rear side plate 115g so as to be arranged substantially parallel and opposite to the right lower stay 113gb. The front stay 113gd is arranged in a direction parallel to the rear side plate 115g (i.e., in the lateral direction) so as to connect the left stay 113gc and the right front strut 114ga.

In addition, the sheet discharge frame body 100g includes a front strut 114gb, an upper stay 113ge, and a right upper stay 113gf. The front strut 114gb is arranged substantially parallel to the right front strut 114ga, and is positioned further to the right side of the center of the front stay 113gd disposed between the left stay 113gc and the right lower stay 113gb with respect to the lateral direction. The front strut 114gb is connected to the front stay 113gd. The upper stay 113ge is arranged substantially parallel to the right upper stay 113ga so as to connect the front strut 114gb and the rear side plate 115g. The right upper stay is arranged substantially parallel to the front stay 113gd so as to connect the right front strut 114ga and the front strut 114gb. The aforementioned sheet discharge unit 700 is assembled into a space defined by these right front strut 114ga, front strut 114gb, right upper stay 113ga, right lower stay 113gb, upper stay 113ge, right upper stay 113gf, and rear side plate 115g.

As illustrated in FIG. 3B, the imaging frame body 100f includes a right front strut 114fa, a left front strut 114fb, a rear side plate 115f, a right upper stay 113fa, a right lower stay 113fb, a left upper stay 113ff, a left lower stay 113fc, a front upper stay 113fe, and a front lower stay 113fd. The right front strut 114fa extends in the vertical direction. The right upper and lower stays 113fa and 113fb are arranged substantially parallel to each other in vertical alignment with respect to the right front strut 114fa, and each connect the right front strut 114fa and the rear side plate 115f. The left front strut 114fb extends in the vertical direction so as to be arranged substantially parallel and opposite to the right front strut 114fa. The left upper and lower stays 113ff and 113fc are arranged substantially parallel to each other in vertical alignment with respect to the left front strut 114fb, and each connect the left front strut 114fb and the rear side plate 115f. The front upper stay 113fe is arranged in a direction parallel to the rear side plate 115f (i.e., in the lateral direction) so as to connect the right front strut 114fa and the left front strut 114fb at their upper end portions. The front lower stay 113fd is arranged in the direction parallel to the rear side plate 115f (i.e., in the lateral direction) so as to connect the right front strut 114fa and the left front strut 114fb at their lower end portions. In the imaging frame body 100f, the right front strut 114fa, the left front strut 114fb, and reinforcement members 1151, which correspond to struts disposed in the rear side plate 115f, are respectively arranged at four corners of the frame body to ensure the rigidity of the frame body. The reinforcement members 1151 are disposed at both end portions in the lateral direction of the rear side plate 115f.

As illustrated in FIG. 3C, the sheet supply frame body 100e includes a right front strut 114ea, a left front strut 114eb, a rear side plate 115e, a right upper stay 113ea, a right lower stay 113eb, a left upper stay 113ef, a left lower stay 113ec, a front upper stay 113ee, and a front lower stay 113ed. The right front strut 114ea extends in the vertical direction. The right upper and lower stays 113ea and 113eb are arranged substantially parallel to each other in vertical alignment with respect to the right front strut 114ea, and each connect the right front strut 114ea and the rear side plate 115e. The left front strut 114eb extends in the vertical direction so as to be arranged substantially parallel and opposite to the right front strut 114ea. The left upper and lower stays 113ef and 113ec are arranged substantially parallel to each other in vertical alignment with respect to the left front strut 114eb, and each connect the left front strut 114eb and the rear side plate 115e. The front upper stay 113ee is arranged in a direction parallel to the rear side plate 115e (i.e., in the lateral direction) so as to connect the right front strut 114ea and the left front strut 114eb at their upper end portions. The front lower stay 113ed is arranged in the direction parallel to the rear side plate 115e (i.e., in the lateral direction) so as to connect the right front strut 114ea and the left front strut 114eb at their lower end portions. To be noted, in the vertical direction, the connection position of the right upper stay 113ea with respect to the right front strut 114ea and the connection position of the left upper stay 113ef with respect to the left front strut 114eb are below the connection positions of the front upper stay 113ee with respect to the right and left front struts 114ea and 114eb. In the sheet supply frame body 100e, the right front strut 114ea, the left front strut 114eb, and reinforcement members 1152, which correspond to struts disposed in the rear side plate 115e, are respectively arranged at four corners of the frame body to ensure the rigidity of the frame body. The reinforcement members 1152 are disposed at both end portions in the lateral direction of the rear side plate 115e.

As an example, the imaging block 120 is mounted onto the sheet supply block 110 in a state in which the right front strut 114fa of the imaging frame body 100f is placed on the right front strut 114ea of the sheet supply frame body 100e, the left front strut 114fb of the imaging frame body 100f is placed on the left front strut 114eb of the sheet supply frame body 100e, and, further, the reinforcement members of the rear side plate 115f of the imaging frame body 100f are placed on the reinforcement members of the rear side plate 115e of the sheet supply frame body 100e. As an example, the sheet discharge block 130 is mounted onto the imaging block 120 in a state in which the right front strut 114ga of the sheet discharge frame body 100g is placed on the right front strut 114fa of the imaging frame body 100f, and the reinforcement members of the rear side plate 115g of the sheet discharge frame body 100g is placed on the reinforcement members of the rear side plate 115f of the imaging frame body 100f.

As described above, the image forming apparatus 1 of this embodiment includes three separable structures: the sheet supply, imaging, and sheet discharge blocks 110, 120, and 130. These sheet supply, imaging, and sheet discharge blocks 110, 120, and 130 respectively include the sheet supply, imaging, and sheet discharge frame bodies 100e, 100f, and 100g, and various units provided with electrical members, individual electrical members, control boards, and the like are disposed within the frame bodies of each block. In addition, the sheet supply frame body 110e of the sheet supply block 110, the imaging frame body 100f of the imaging block 120, and the sheet discharge frame body 110g of the sheet discharge block 130 are configured to be separable from each other. Thereby, it is possible to assemble the apparatus 1A by stacking the sheet supply, imaging, and sheet discharge blocks 110, 120, and 130 with each block pre-assembled with various units, individual electrical members, control boards, and the like for each block; therefore, it is possible to improve the product quality of the apparatus body 1A while substantially reducing assembly work hours of the apparatus body 1A. To be noted, in this specification, the term “electrical members” refers to devices such as motors, sensors, switches, heaters, and the like, which physically operate based on electrical control in accordance with driving signals.

### Electrical System

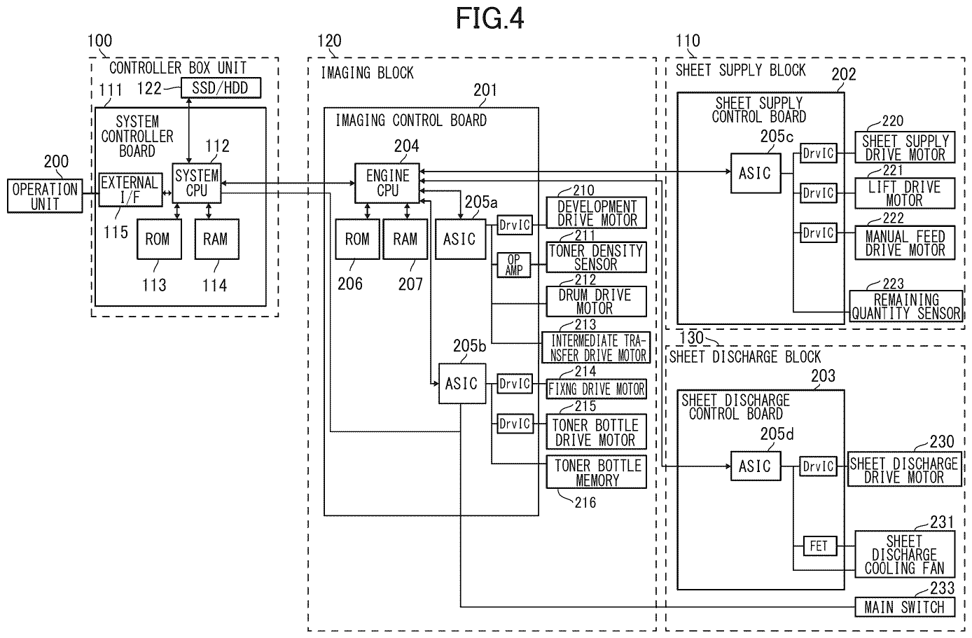

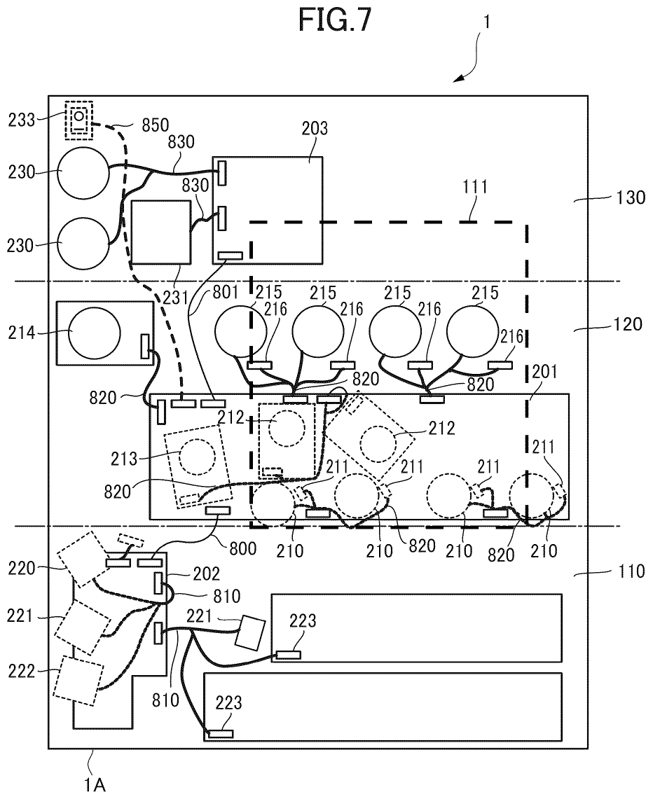

Next, with reference to FIG. 2, using FIG. 4, an example of an electrical system that controls operations of the image forming apparatus 1 will be described. The electrical system of the image forming apparatus 1 illustrated in FIG. 4 includes a system controller board 111, an imaging control board 201, a sheet supply control board 202, and a sheet discharge control board 203. The sheet supply, imaging, and sheet discharge control boards 202, 201, and 203 are disposed on the rear side of the respective sheet supply, imaging, and sheet discharge frame bodies 100e, 100f, and 100g described above. The sheet supply, imaging, and sheet discharge control boards 202, 201, and 203 each may be arranged to overlap the electrical members which serve as their respective control objects, when viewed from the rear side. In addition, the sheet supply, imaging, and sheet discharge control boards 202, 201, and 203 each may be arranged to overlap the electrical members which serve as their respective control objects, when viewed in a direction perpendicular to each control board. For example, as illustrated in FIG. 7 described below, a development drive motor 210, a toner density sensor 211, a drum drive motor 212, and an intermediate transfer drive motor 213 are drive-controlled by the imaging control board 201, and are arranged to overlap the imaging control board 201 when viewed from the rear side of the image forming apparatus 1. In addition, a sheet supply drive motor 220, a lift drive motor 221, and a manual feed drive motor 222 are drive-controlled by the sheet supply control board 202, and are arranged to overlap the sheet supply control board 202 when viewed from the rear side of the image forming apparatus 1.

### System Controller Board

The system controller board 111 includes an external interface (external I/F) 115 for inputting and outputting signals to and from external devices, and executes various control processes in response to instructions from an operation unit 200 connected via the external I/F 115. In addition, the system controller board 111 includes a system central processing unit (system CPU) 112, a read only memory (ROM) 113, which stores control programs, and a random access memory (RAM) 114, which temporarily stores data. The system CPU 112 centrally administers the operations of the entire image forming apparatus based on the control programs stored in the ROM 113.

The system controller board 111, serving as a main control board, is disposed inside a controller box unit 100 with a solid state drive or hard disk drive (SSD/HDD) 122. The SSD/HDD 122 is a high-capacity storage device for storing electronic data, and is primarily used to store image processing programs, digital image data, and metadata associated with digital image data. The controller box unit 100 is disposed on the rear side of the sheet supply, imaging, and sheet discharge frame bodies 100e, 100f, and 100g in a manner extending across either one or a plurality of blocks among the sheet supply, imaging, and sheet discharge blocks 110, 120, and 130. To be noted, in a case where an area of the system controller board 111 is greater than each area of the imaging, sheet supply, and sheet discharge boards 201, 202, and 203, the system controller board 111 is disposed within the apparatus body 1A such that, when viewed from the rear side of the image forming apparatus 1, a part of the system controller board 111 is arranged to overlap any of the control boards (201, 202, 203) (refer to FIG. 7 described below). In other words, when viewed in a direction perpendicular to the system controller board 111, a part of the system controller board 111 is arranged to overlap the imaging control board 201. In addition, when viewed in the direction perpendicular to the system controller board 111, a part of the system controller board 111 is arranged to overlap the sheet discharge control board 203. The direction perpendicular to the system controller board 111 is a direction perpendicular to a planar direction in which the system controller board 111 extends.

### Imaging Control Board

The imaging control board 201, which performs image formation control to form the toner image on the recording material S is disposed in the imaging block 120. The imaging control board 201 includes an engine central processing unit (engine CPU) 204, a ROM 206, which stores programs that control each unit, a RAM 207, which temporarily stores data, and application specific integrated circuits (ASICs) 205a and 205b. The engine CPU 204, which serves as an image formation engine, executes various control processes in the imaging block 120 based on the control programs stored in the ROM 206 under the control of the system CPU 112. Further, under the control of the system CPU 112, the engine CPU 204 integrally controls the image formation process, including the supply of the recording material S, the image formation onto the recording material S, and the discharge of the recording material S. In other words, the engine CPU 204 can be regarded as an integrated control unit for the image formation. In particular, in addition to controlling the ASICs 205 and 205b arranged in the same imaging control board 201, the engine CPU 204 controls control units (ASICs 205c and 205d) in the boards of the other blocks.

The ASIC 205a is electrically connected to each of electrical members such as the development drive motor 210, which drives the developing unit 14, the toner density sensor 211, which detects toner density within the developing unit 14, the drum drive motor 212, which drives the photosensitive drum 11, the intermediate transfer drive motor 213, which drives the intermediate transfer belt unit 600, via a wire bundle. On the other hand, the ASIC 205b is electrically connected to each of electrical members such as a fixing drive motor 214, which drives the fixing unit 50, a toner bottle drive motor 215, which drives the toner bottle 90, and a toner bottle memory 216, which stores a remaining quantity of the toner within the toner bottle 90, via a wire bundle. That is, the ASICs 205a and 205b, serving as a first control unit of the imaging control board 201, control these electrical members, which are disposed in the same imaging block 120 as the imaging control board 201, by transmitting a driving signal (first driving signal) based on a control signal from the engine CPU 204. The development drive motor 210, the toner density sensor 211, the drum drive motor 212, the intermediate transfer drive motor 213, the fixing drive motor 214, the toner bottle drive motor 215, and the toner bottle memory 216 are examples of a first electrical member disposed in the imaging frame body 100f, serving as a first frame body. These first electrical members are controlled by the imaging control board 201, serving as a first control board disposed in the imaging frame body 100f.

### Sheet Supply Control Board

The sheet supply control board 202, which performs the supply control of the recording material S stored in the cassettes 31 and 32, is disposed in the sheet supply block 110. The sheet supply control board 202 includes the ASIC 205c, serving as a second control unit. The ASIC 205c is electrically connected to each of electrical members such as the sheet supply drive motor 220, which drives the sheet supply unit 300, the lift drive motor 221, which drives lifters disposed in a manner capable of moving vertically within the cassettes 31 and 32, the manual feed drive motor 222, which drives a manual feed supply roller for feeding the recording material S set on a manual feed tray, not shown, a remaining quantity sensor 223, which detects a remaining quantity of the recording material S stored within the cassettes 31 and 32, via a wire bundle. In addition, the ASIC 205c is electrically connected to the engine CPU 204 via a wire bundle. That is, the ASICs 205c of the sheet supply control board 202 controls those electrical members, which are disposed in the same sheet supply block 110 as the sheet supply control board 202, by transmitting a driving signal (second driving signal) based on a control signal from the engine CPU 204. The sheet supply drive motor 220, the lift drive motor 221, the manual feed drive motor 222, and the remaining quantity sensor 223 are examples of a second electrical member disposed in the sheet supply frame body 100e, serving as a second frame body. These second electrical members are controlled by the sheet supply control board 202, serving as a second control board disposed in the sheet supply frame body 100e.

In the description above, the imaging frame body 100f serves as an example of the first frame body, and the sheet supply frame body 100e serves as an example of the second frame body; however, it is not limited to this. Among the three frame bodies: the sheet supply, imaging, and sheet discharge frame bodies 100e, 100f, and 100g included in the image forming apparatus 1, any one may be designated as the first frame body, and any one of the remaining frame bodies may be designated as the second frame body. Then, among the three frame bodies, one frame body other than the first and second frame bodies may be designated as a third frame body. The same applies to electrical members and control boards, in which the first electrical members and the first control board are disposed in the first frame body, the second electrical members and the second control board are disposed in the second frame body, and third electrical members and a third control board are disposed in the third frame body. Then, when separating the first and second frame bodies, the first electrical members and the first control board are arranged in the first frame body, and the second electrical members and the second control board are arranged in the second frame body. At this time, the wire bundle (communication line), serving as a first wire bundle connecting the first electrical members and the first control board, is entirely arranged within the first frame body, and the wire bundle (communication line), serving as a second wire bundle connecting the second electrical members and the second control board, is entirely arranged within the second frame body. In addition, when separating the second and third frame bodies, the second electrical members and the second control board are arranged on the side of the second frame body, and the third electrical members and the third control board are arranged in the third frame body. At this time, the wire bundle (communication line) serving as the second wire bundle connecting the second electrical members and the second control board is arranged on the side of the second frame body, and the wire bundle (communication line) serving as a third wire bundle (communication line) connecting the third electrical members and the third control board is arranged on the side of the third frame body.

### Sheet Discharge Control Board

The sheet discharge control board 203, which performs the sheet discharge control of the recording material S to the outside, is disposed in the sheet discharge block 130. The sheet discharge control board 203 includes the ASIC 205d. The ASIC 205d is electrically connected to electrical members such as a sheet discharge drive motor 230, which drives the sheet discharge unit 700, via a wire bundle. In addition, the ASIC 205d is electrically connected to the engine CPU 204 via a wire bundle. That is, the ASICs 205d of the sheet discharge control board 203 controls those electrical members, which are disposed in the same sheet discharge block 130 as the sheet discharge control board 203, by transmitting a driving signal based on a control signal from the engine CPU 204.

In this embodiment, based on coordinated control between the system CPU 112 of the system controller board 111 and the engine CPU 204 of the imaging control board 201, the ASICs 205a, 205b, 205c, and 205d control operations of each electrical member described above. The system CPU 112 and the engine CPU 204 are electrically connected via a wire bundle.

To be noted, while the illustration is omitted, the image forming apparatus 1 may be configured such that the recording material S set on the manual feed tray is supplied one sheet at a time to the conveyance path 60. The manual feed tray and a manual feed supply unit, which includes the manual feed supply roller for supplying the recording material S from the manual feed tray, are disposed in the sheet supply block 110. In this case, the ASIC 205c is also connected to the manual feed drive motor 222 (electrical member), which drives the manual feed supply unit. In addition, the image forming apparatus 1 may be configured such that a sheet discharge cooling fan 231 for cooling the recording material S which has been discharged outside is disposed in the sheet discharge block 130. In such a case, the ASIC 205d is also connected to the sheet discharge cooling fan 231.

### Driving Signal Between ASIC and Electrical Member

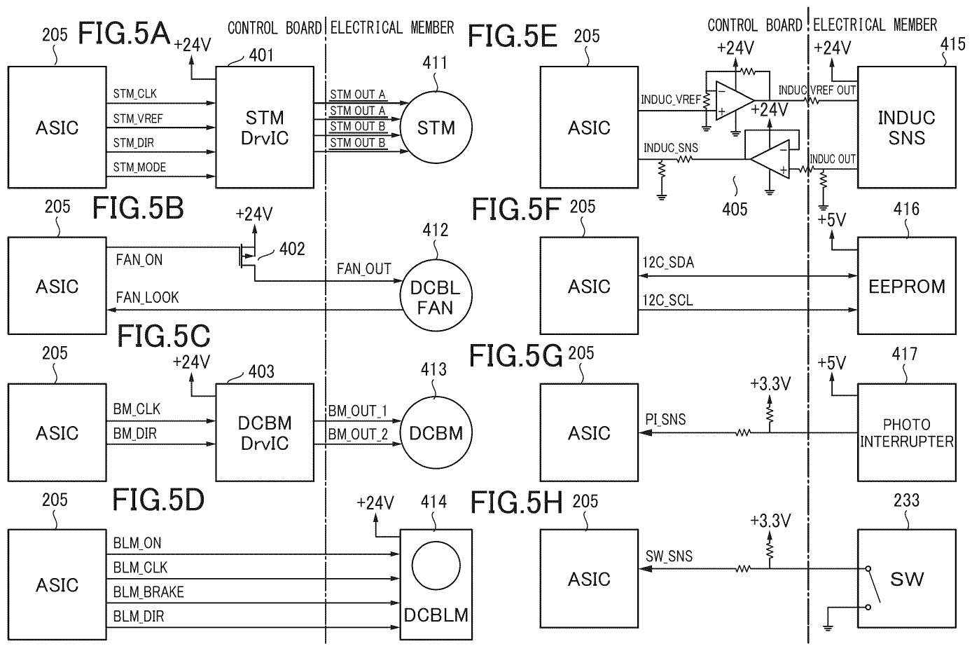

Next, with reference to FIG. 4, using FIGS. 5A to 5H, the driving signals between the ASICs 205 (205a, 205b, 205c, 205d) described above and the electrical members that serve as drive objects by being electrically connected to these ASICs via wire bundles will be described. To be noted, the wire bundles connecting the ASICs 205 and the electrical members, which serve as the drive objects, include at least a communication line capable of transmitting a driving signal, and may also be bundled with a power supply line or the like for supplying power.

FIG. 5A illustrates a case where the electrical member for the drive object is a stepping motor 411. For example, the stepping motor 411 is applied to the development drive motor 210, the sheet supply drive motor 220, the manual feed drive motor 222, and the sheet discharge drive motor 230. The ASIC 205 is connected to a “stepping motor driver (STMDrv)” integrated circuit (IC) 401 for operating the stepping motor 411, and controls the stepping motor 411 using the following signals via the “STMDrv” IC 401. A “stepping motor clock (STM_CLK)” signal is a pulse-width modulation (PWM) signal with a 50% duty cycle, and serves as a signal that increments an electrical angle of the stepping motor 411 by one step per pulse. The “stepping motor voltage reference (STM_VREF)” signal is a 100 kilohertz (KHz) PWM signal, and serves as a reference for determining an output current of the stepping motor 411. These PWM signals are smoothed by a resistor-capacitator (RC) filter circuit (not shown), and is input as a direct current (DC) signal to the “STMDrv” IC 401. The “STMDrv” IC 401 determines a drive current of the stepping motor 411 in accordance with a voltage level of the input DC signal.

A “stepping motor direction (STM_DIR)” signal serves as a signal for determining a rotational direction of the stepping motor 411. When the “STM_DIR” signal outputs “H”, the stepping motor 411 rotates in the forward direction, and, when the “STM_DIR” signal outputs “L”, the stepping motor 411 rotates in the reverse direction. A “stepping motor mode (STM_MODE)” signal serves as a signal used for setting an excitation mode of the stepping motor 411, and is, for example, a 2-bit DC signal. For example, when “MODE0:1=‘H:H”, the driver is set to a 2 phase excitation mode, and, when “MODE0:1=‘H:L”, the driver is set to a 1-2 phase excitation mode. Output to the stepping motor 411 is executed based on the configuration to the “STMDrv” IC 401 via these signals.

FIG. 5B illustrates a case where a DC brushless fan 412 serves as the electrical member for the drive object. For example, the DC brushless fan 412 is applied to the sheet discharge cooling fan 231. When the “fan turned on (FAN_ON)” signal is output from the ASIC 205, a field-effect transistor (FET) 402 is turned ON, and a +24 volts (V) DC voltage is supplied to the DC brushless fan 412. When the +24 V DC voltage is input, the DC brushless fan 412 commences rotation. When commencing the rotation, the DC brushless fan 412 outputs a “fan look (FAN_LOOK)” signal. The ASIC 205 detects a rotation operation of the DC brushless fan 412 through the “FAN_LOOK” signal.

FIG. 5C illustrates a case where a DC brush motor 413 serves as the electrical member for the drive object. For example, the DC brush motor 413 is applied to the toner bottle drive motor 215 and the lift drive motor 221. The ASIC 205 is connected to a “DC brush motor driver (DCBM Drv)” IC 403 to operate the DC brush motor 413, and controls the DC brush motor 413 through the following signals via the “DCBM Drv” IC 403. A “brush motor clock (BM_CLK)” signal is a variable duty PWM signal at 20 KHz, and the “DCBM Drv” IC 403 controls a rotational speed of the DC brush motor 413 based on a duty ratio of the PWM signal. A “brush motor direction (BM_DIR)” signal serves as a signal for determining a rotational direction of the DC brush motor 413. When the “BM_DIR” signal outputs “H”, the DC brush motor 413 rotates in the forward direction, and, when the “BM_DIR” signal outputs “L”, the DC brush motor 413 rotates in the reverse direction.

FIG. 5D illustrates a case where a DC brushless motor 414 serves as the electrical member for the drive object. For example, the DC brushless motor 414 is applied to the drum drive motor 212, the intermediate transfer drive motor 213, and the fixing drive motor 214. A “brushless motor clock (BLM_CLK)” signal is a PWM signal with a 50% duty cycle, and serves as a signal for transmitting a setting speed to the DC brushless motor 414. A “brushless motor direction (BLM_DIR)” signal serves as a signal for determining a rotational direction of the DC brushless motor 414. When the “BLM_DIR” signal outputs “H”, the DC brushless motor 414 rotates in the forward direction, and, when the “BLM_DIR” signal outputs “L”, the DC brushless motor 414 rotates in the reverse direction. A “brushless motor brake (BLM_BRAKE)” signal serves as a signal for activating a short brake of the DC brushless motor 414. When the “BLM_BRAKE” signal outputs “H”, the DC brushless motor 414 activates the short brake by shorting motor coils so as to shorten the time required for the rotation to stop.

FIG. 5E illustrates a case where an inductor sensor 415 serves as the electrical member for the drive object. For example, the inductor sensor 415 is applied to the toner density sensor 211. An “inductor voltage reference (INDUC_VREF)” signal is a signal for generating a reference voltage for the inductor sensor 415, and is transmitted to the inductor sensor 415 after signal amplification by an operational amplifier circuit 405. The inductor sensor 415 detects a ratio of the toner to the carrier in the developer stored within the developing unit 14, and outputs an “inductor output (INDUC_OUT)” signal corresponding to the ratio. The “INDUC_OUT” signal is converted to a 3.3 V range by the operational amplifier circuit 405, and input to the ASIC 205 as an “inductor sensor (INDUC_SNS)” signal. The ASIC 205 incorporates an analog-to-digital (A/D) conversion circuit, and detects a voltage value by converting the input “INDUC_SNS” signal to a digital value.

FIG. 5F illustrates a case where an electrically erasable programmable read-only memory (EEPROM) 416 serves as the electrical member for the drive object. The EEPROM 416 is, for example, applied to the toner bottle memory 216. Data communication between the ASIC 205 and the EEPROM 416 is performed via serial communication such as inter-integrated circuit (I2C) communication, and the ASIC 205 reads and writes data to and from the EEPROM 416.

FIG. 5G illustrates a case where a photo-interrupter 417 serves as the electrical member for the drive object. The photo-interrupter 417 is, for example, applied to the remaining quantity sensor 223. A “photo-interrupter sensor (PI_SNS)” signal is a signal output by the photo-interrupter 417, and the photo-interrupter 417 respectively outputs “L” and “H” during light transmission and light blocking. The ASIC 205 can detect the remaining quantity of the recording material S by receiving the “PI_SNS” signal.

FIG. 5H illustrates a case where a main switch 233 serves as the electrical member for the drive object. A “switch sensor (SW_SNS)” signal is a signal output by the main switch 233, and the main switch 233 outputs “L” when the switch is activated, and “H” and outputs “H” when the switch is deactivated. The ASIC 205 can detect the on/off state of the main switch 233 by receiving the “SW_SNS” signal.

### Control Signal Between Engine CPU and ASIC

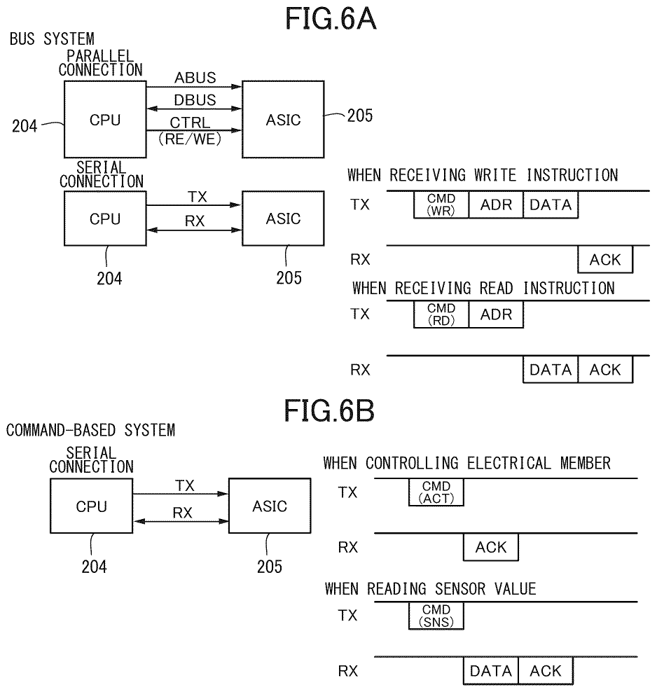

Next, with reference to FIG. 4, using FIGS. 6A and 6B, the control signal between the engine CPU 204 of the imaging control board 201 and the ASICs 205c and 205d, which are electrically connected to the engine CPU 204 via the wire bundles, will be described. In this embodiment, either a “bus system” or a “command-based system” may be adopted as a method for transferring data between the engine CPU 204 and the ASICs 205c and 205d. To be noted, the wire bundles connecting the engine CPU 204 and the ASICs 205c and 205d include at least a communication line capable of transmitting the control signal. In addition, the control signal transmitted from the engine CPU 204 is a digital signal represented by a combination of two logical values. As described below, this digital signal includes at least one of an address signal, a read instruction, a write instruction, and control data.

FIG. 6A illustrates cases where the “bus system” is employed, and the engine CPU 204 and the ASIC 205 are connected in parallel and in series. First, the case where the engine CPU 204 and the ASIC 205 are connected in parallel will be described. The engine CPU 204 transmits signals such as address signals, control data, and read/write instructions to the ASIC 205 simultaneously via a plurality of communication lines. The plurality of communication lines constitute a bus system capable of parallel transfer, and include an address bus (ABUS), a data bus (DBUS), and a control bus (CTRL) incorporating read enable signals (RE) and write enable signals (WE).

For example, in a case where the engine CPU 204 has transmitted an address signal and a read instruction (execution command) to the ASIC 205, the ASIC 205 retrieves data stored at an address (location) corresponding to the address signal from a memory within the ASIC 205, and transmits the retrieved data to the engine CPU 204. The engine CPU 204 stores the data retrieved from the memory within the ASIC 205 in the RAM 207. On the other hand, in a case where the engine CPU 204 has transmitted an address signal, a write instruction (execution command), and data to the ASIC 205, the ASIC 205 writes the received data to an address corresponding to the address signal in the memory within the ASIC 205. By referencing the data stored in the memory within the ASIC 205, the ASIC 205 (205c, 205d) transmits a driving signal that actuates an electrical member, and thereby controls such an electrical member.

Next, the case where the engine CPU 204 and the ASIC 205 are serially connected will be described. When a command (CMD) is a write instruction (WR), the engine CPU 204 chronologically transmits the write instruction, an address signal (ADR), and data (DATA) through a communication line (serial bus TX) to the ASIC 205. In this case, the ASIC 205 writes the received data to an address corresponding to the address signal in the memory within the ASIC 205. Then, the ASIC 205 transmits a response signal (acknowledgment (ACK)), indicating whether or not the data write operation corresponding to the write instruction was performed correctly, to the engine CPU 204 through a communication line (serial bus RX).

On the other hand, when the command (CMD) is a read instruction (RD), the engine CPU 204 chronologically transmits the read instruction and an address signal (ADR) to the ASIC 205 through the communication line (serial bus TX). When the ASIC 205 receives the read instruction and the address signal from the engine CPU 204, the ASIC 205 retrieves data stored at an address (location) corresponding to the address signal from the memory within the ASIC 205, and transmits the retrieved data (DATA) to the engine CPU 204 through the communication line (serial bus RX). Thereafter, the ASIC 205 transmits a response signal (ACK), indicating whether or not the data retrieval operation corresponding to the read instruction was performed correctly, to the engine CPU 204 through the communication line (serial bus RX). Thereby, even with the serial connection that reduces the number of communication lines between the engine CPU 204 and the ASIC 205, it is possible to transmit and receive the same control signal as in the parallel connection described above.

FIG. 6B illustrates a case where the engine CPU 204 and the ASIC 205 (205c, 205d) are serially connected by adopting the “command-based system”. In a case of controlling electrical members, the engine CPU 204 transmits a predetermined control command (activation command (CMD(ACT)), which is determined in advance corresponding to an electrical member for a drive object, via the communication line (serial bus transmit (TX)) to the ASIC 205. In a case of having received the control command from the engine CPU 204, the ASIC 205 transmits a response signal (ACK), indicating whether or not the command was received correctly, via the communication line (serial bus receive (RX)) to the engine CPU 204. By receiving the control command from the engine CPU 204, the ASIC 205 controls the electrical member by outputting a driving signal to drive such an electrical member. For example, in a case of receiving a detection result from the remaining quantity sensor 223 (during sensor value reading), the engine CPU 204 transmits a sensor value read command (CMD(SNS)) to the ASIC 205. In a case of having received the sensor value read command from the engine CPU 204, the ASIC 205 receives the sensor value from the remaining quantity sensor 223, and transmits the received sensor value (DATA) to the engine CPU 204. Thereafter, the ASIC 205 transmits a response signal (ACK), indicating whether or not the sensor value acquisition operation from the remaining quantity sensor 223 was performed correctly, to the engine CPU 204.

### Layout and Wiring of Control Board and Electrical Member

Next, with reference to FIGS. 3 and 4, using FIGS. 7 to 9, a layout and the wiring of the control boards and electrical members in the electrical system illustrated in FIG. 4 will be described. As illustrated in FIG. 7, the image forming apparatus 1 includes three blocks: the sheet supply, imaging, and sheet discharge blocks 110, 120, and 130, which are sequentially arranged from bottom to top, and the sheet supply, imaging, and sheet discharge control boards 202, 201, and 203 are disposed in the frame bodies of each respective block.

In the case of this embodiment, as described above, the sheet supply control board 202 disposed in the sheet supply block 110 controls the electrical members disposed in the sheet supply block 110. The imaging control board 201 disposed in the imaging block 120 controls the electrical members disposed in the imaging block 120. The sheet discharge control board 203 disposed in the sheet discharge block 130 controls the electrical members disposed in the sheet discharge block 130 (however, excluding the main switch 233). That is, the electrical members that serve as the drive objects of the sheet supply, imaging, and sheet discharge control boards 202, 201, and 203 are disposed in the same block in which their respective control boards are disposed. This is to retain the wire bundles, which electrically connect each control board to the electrical members for the drive objects, within each block. In addition, in some blocks, the wiring that connects the control board to the electrical members for the drive objects may be routed externally to the block. It is acceptable that, in at least one block, a wiring network connecting the control board to the electrical members for the drive objects is disposed within that block.

As illustrated in FIG. 7, the sheet supply control board 202 (in particular, ASIC 205c) is electrically connected to the sheet supply drive motor 220, the lift drive motor 221, the manual feed drive motor 222, and the remaining quantity sensor 223, which are the drive objects of the sheet supply control board 202, via a wire bundle 810. The wire bundle 810, serving as a second communication line, is arranged within the sheet supply frame body 100e (inside the frame body) of the sheet supply block 110. The wire bundle 810 is detachably disposed to at least one of the sheet supply control board 202 (in particular, ASIC 205c) and each of the sheet feed drive motor 220, the lift drive motor 221, the manual feed drive motor 222, and the remaining quantity sensor 223.

In addition, the imaging control board 201 (in particular, ASICs 205a and 205b) is electrically connected to the development drive motor 210, the toner density sensor 211, the drum drive motor 212, the intermediate transfer drive motor 213, the fixing drive motor 214, the toner bottle drive motor 215, and the toner bottle memory 216, which are the drive objects of the imaging control board 201, via a wire bundle 820. The wire bundle 820, serving as a first communication line, is arranged within the imaging frame body 100f of the imaging block 120. The wire bundle 820 is detachably disposed to at least one of the imaging control board 201 (in particular, ASICs 205a and 205b) and each of the development drive motor 210, the toner density sensor 211, the drum drive motor 212, the intermediate transfer drive motor 213, the fixing drive motor 214, the toner bottle drive motor 215, and the toner bottle memory 216.

Further, the sheet discharge control board 203 (in particular, ASIC 205d) is electrically connected to the sheet discharge drive motor 230 and the sheet discharge cooling fan 231, which are the drive objects of the sheet discharge control board 203, via a wire bundle 830. The wire bundle 830 is arranged within the sheet discharge frame body 100g of the sheet discharge block 130. The wire bundle 830 is detachably disposed to at least one of the sheet discharge control board 203 (in particular, ASIC 205d) and each of the sheet discharge drive motor 230 and the sheet discharge cooling fan 231. While, in this manner, each control board and the electrical members for the drive objects are connected via the wire bundles 810, 820, and 830, by arranging each control board and the electrical members for the drive objects in the same block as described above, the wiring of the wire bundles 810, 820, and 830 can be completed within each block.

On the other hand, the imaging control board 201 (in particular, engine CPU 204) and the ASIC 205c of the sheet supply block 110 are electrically connected via a wire bundle 800. The wire bundle 800 is routed across a boundary between the imaging frame body 100f of the imaging block 120 and the sheet supply frame body 110e of the sheet supply block 110. In addition, the imaging control board 201 (in particular, engine CPU 204) and the ASIC 205d of the sheet discharge block 130 are electrically connected via a wire bundle 801. The wire bundle 801 is routed across a boundary between the imaging frame body 100f of the imaging block 120 and the sheet discharge frame body 100g of the sheet discharge block 130. In this manner, by connecting the imaging control board 201, incorporating the engine CPU 204, and the sheet supply and discharge control boards 202 and 203, which do not incorporate the engine CPU 204 but incorporate only the ASICs 205c and 205d, using only the wire bundles 800 and 801 (control communication lines), it is possible to achieve the inter-block connections with a simplified configuration. The wire bundle 800 is detachably mounted to at least one of the imaging and sheet supply control boards 201 and 202. The wire bundle 801 is detachably mounted to at least one of the imaging and sheet discharge control boards 201 and 203.

To be noted, in the embodiment described above, the imaging control board 201 includes two ASICs: the ASICs 205a and 205b. For electrical members, such as the main switch 233, that transmit signals to the system CPU 112 and the engine CPU 204, it may not always be optimal to complete an electrical connection via a wire bundle within the same block. In this case, as illustrated in FIG. 7, the main switch 233 and the imaging control board 201 (in particular, ASIC 205d) are electrically connected via a wire bundle 850, which is routed across the boundary between the sheet discharge frame body 100g of the sheet discharge block 130 and the imaging frame body 100f of the imaging block 120. In such a case, by adopting a configuration in which the ASIC 205a, whose connections are completed within the imaging block 120, is segregated from the ASIC 205b, which includes a connection to the sheet discharge control board 203, the wiring of the wire bundle 820 is completed within the imaging block 120 with respect to at least one ASIC 205a.

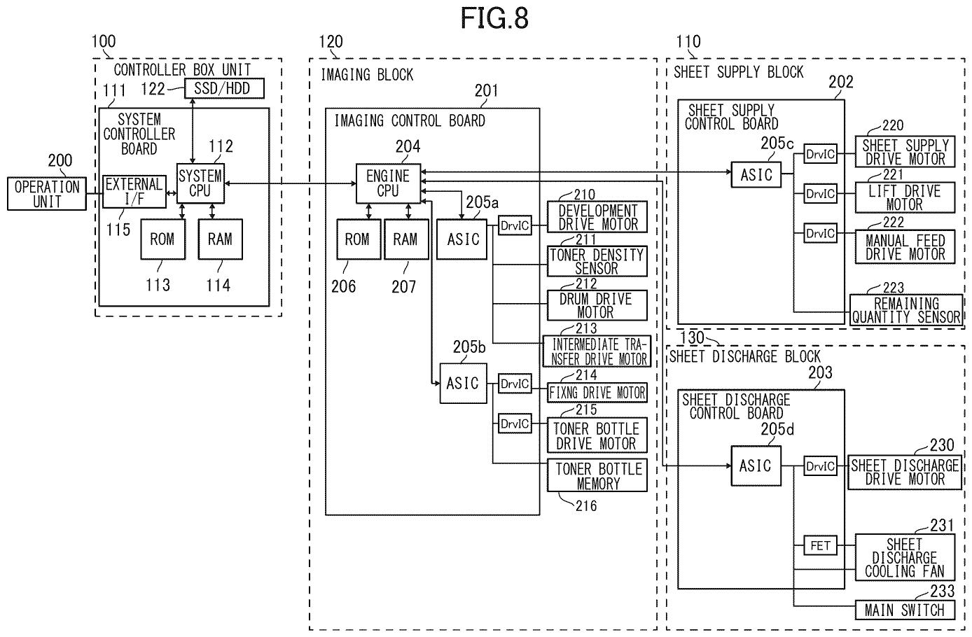

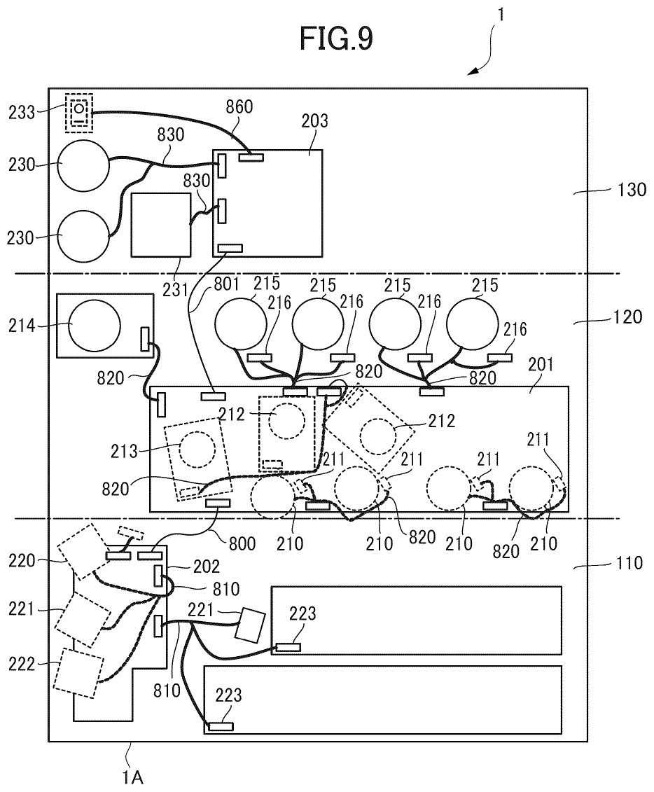

In contrast, as illustrated in FIG. 8, the main switch 233 may be configured as the drive object of the ASIC 205d of the sheet discharge control board 203, and, as illustrated in FIG. 9, the main switch 233 and the sheet discharge control board 203 may be electrically connected via a wire bundle 860. In this case, the detection signal of the main switch 233 is transmitted to the ASIC 205d of the sheet discharge control board 203, and the engine CPU 204 can detect this signal via communication with the ASIC 205d. In addition, this configuration allows the state of the main switch 233 to be notified via communication from the engine CPU 204 to the system CPU 112. With such a configuration, as illustrated in FIG. 9, the wire bundle 860, connecting the main switch 233 and the sheet discharge control board 203, can be enclosed within the sheet discharge block 130 without extending across the boundary between the imaging frame body 100f of the imaging block 120 and the sheet discharge frame body 100g of the sheet discharge block 130.

As described above, in this embodiment, the ASICs 205 of each control board (202, 201, 203) and the electrical members for the drive objects are electrically connected within each block (110, 120, 130) via the wire bundles (810, 820, 830). By arranging each control board including the ASIC 205 within the same frame body (100e, 100f, 100g) as the electrical members for the drive objects, it is possible to arrange the wire bundles (810, 820, 830) within the frame bodies (100e, 100f, 100g) of each block. That is, the wire bundles (810, 820, 830) can be routed without extending across the boundaries between the plurality of frame bodies (100e, 100f, 100g), and it is possible to ensure proper routing of the wiring. Thereby, the wire bundles that are routed across the boundaries between the frame bodies (100e, 100f, 100g) can be limited to the wire bundles 800 and 801, which connect the engine CPU 204 of the imaging control board 201 to the ASIC 205c of the sheet supply control board 202 and the ASIC 205d of the sheet discharge control board 203.

In a case where a service technician performs maintenance work on the image forming apparatus 1, it is efficient to work on each block (110, 120, 130) individually. With the configuration of this embodiment, described above, when the service technician removes the wire bundles (810, 820, 830) connected to electrical members requiring maintenance, which are electrically connected to the control board, the technician does not need to access other frame bodies that do not include the electrical members requiring maintenance. Therefore, it is possible to improve the maintainability of the electrical members by the service technician. In addition, since the electrical members and the control boards that control these electrical members are arranged within the same block and connected via the wire bundles, the wire bundles can be configured to be short, and the weight of the image forming apparatus 1 can be suppressed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-187395, filed Oct. 24, 2024, which is hereby incorporated by reference herein in its entirety.

What is claimed is:

1. An image forming apparatus configured to form an image on a recording material, the image forming apparatus comprising:
an apparatus body including at least a first frame body and a second frame body which are disposed in a vertical direction;
a first electrical member disposed in the first frame body and configured to operate physically based on electrical control;
a second electrical member disposed in the second frame body and configured to operate physically based on electrical control;
a first control board disposed in the first frame body, connected to the first electrical member, and configured to control the first electrical member; and
a second control board disposed in the second frame body, connected to the second electrical member, and configured to control the second electrical member.

2. The image forming apparatus according to claim 1, wherein the first frame body and the second frame body are configured to be separated from each other,
wherein, in a case where the first frame body and the second frame body are separated, the first electrical member and the first control board are arranged in the first frame body, and
wherein, in a case where the first frame body and the second frame body are separated, the second electrical member and the second control board are arranged in the second frame body.

3. The image forming apparatus according to claim 1, further comprising a first wire bundle configured to connect the first electrical member and the first control board,
wherein the first wire bundle is entirely arranged within the first frame body.

4. The image forming apparatus according to claim 3, further comprising a second wire bundle configured to connect the second electrical member and the second control board,
wherein the second wire bundle is entirely arranged within the second frame body.

5. The image forming apparatus according to claim 1, further comprising a communication line,
wherein the first control board includes a first control unit configured to generate a driving signal for the first electrical member disposed in the first frame body, and
wherein the communication line is configured to connect the first control unit and the first electrical member, is routed within the first frame body, and is configured to communicate the driving signal transmitted from the first control unit.

6. The image forming apparatus according to claim 1, wherein the first control board includes a first control unit configured to generate a first driving signal for driving the first electrical member,
wherein the second control board includes a second control unit configured to generate a second driving signal for driving the second electrical member, and
wherein the first control board includes an integrated control unit configured to transmit a control signal to the first control unit and the second control unit.

7. The image forming apparatus according to claim 6, further comprising:
a first communication line that is configured to connect the first control unit and the first electrical member, is routed within the first frame body, and is configured to communicate the first driving signal transmitted from the first control unit;
a second communication line that is configured to connect the second control unit and the second electrical member, is routed within the second frame body, and is configured to communicate the second driving signal transmitted from the second control unit; and
a control communication line that is configured to connect the integrated control unit of the first control board and the second control unit of the second control board, is routed across a boundary between the first frame body and the second frame body, and is configured to communicate the control signal transmitted from the integrated control unit.

8. The image forming apparatus according to claim 7, wherein the control communication line is detachably mounted to at least one of the integrated control unit and the second control unit.

9. The image forming apparatus according to claim 7, wherein the control signal includes an execution command for the second control unit of the second control board, and
wherein the second control unit is configured to generate the second driving signal in accordance with the execution command transmitted from the integrated control unit.

10. The image forming apparatus according to claim 7, wherein the control signal includes a digital signal including at least one of an address signal, a read instruction, a write instruction, and control data.

11. The image forming apparatus according to claim 1, further comprising a main control board configured to control an operation of the image forming apparatus,
wherein an area of the main control board is greater than each of areas of the first control board and the second control board, and
wherein, a part of the main control board overlaps the first control board when the image forming apparatus is viewed from a rear side.

12. The image forming apparatus according to claim 1, further comprising a main control board configured to control an operation of the image forming apparatus,
wherein an area of the main control board is greater than each of areas of the first control board and the second control board, and
wherein a part of the main control board overlaps the first control board when viewed in a direction perpendicular to the main control board.

13. An image forming apparatus configured to form an image on a recording material, the image forming apparatus comprising:
a first electrical member configured to operate physically based on electrical control;
a second electrical member configured to operate physically based on electrical control;
a first control board that is disposed to overlap the first electrical member when the image forming apparatus is viewed from a rear side, is connected to the first electrical member, and is configured to control drive of the first electrical member; and
a second control board that is disposed to overlap the second electrical member when the image forming apparatus is viewed from the rear side, is connected to the second electrical member, and is configured to control drive of the second electrical member.

14. The image forming apparatus according to claim 13, wherein the first control board includes a first control unit configured to generate a first driving signal for driving the first electrical member,
wherein the second control board includes a second control unit configured to generate a second driving signal for driving the second electrical member, and
wherein the first control board includes an integrated control unit configured to transmit a control signal to the first control unit and the second control unit.

15. The image forming apparatus according to claim 14, further comprising:
a first communication line that is configured to connect the first control unit and the first electrical member, and is configured to communicate the first driving signal transmitted from the first control unit;
a second communication line that is configured to connect the second control unit and the second electrical member, and is configured to communicate the second driving signal transmitted from the second control unit; and
a control communication line that is configured to connect the integrated control unit of the first control board and the second control unit of the second control board, and is configured to communicate the control signal transmitted from the integrated control unit.

16. The image forming apparatus according to claim 14, wherein the control signal includes an execution command for the second control unit of the second control board, and
wherein the second control unit is configured to generate the second driving signal in accordance with the execution command transmitted from the integrated control unit.

17. The image forming apparatus according to claim 14, wherein the control signal includes a digital signal including at least one of an address signal, a read instruction, a write instruction, and control data.
